(19) United States
(12) Patent Application Publication
(10) Pub. No.: US 2021/0269037 A1
(43) Pub. Date: Sep. 2, 2021

(54) SYSTEM AND METHOD TO NAVIGATE AUTONOMOUS VEHICLES

(71) Applicant: Optimum Semiconductor Technologies Inc., Tarrytown, NY (US)

(72) Inventors: Samantha MURPHY, Nashua, NH (US); John GLOSSNER, Nashua, NH (US); Sabin Daniel IANCU, Pleasantville, NY (US)

(73) Assignee: Optimum Semiconductor Technologies Inc., Tarrytown, NY (US)

(21) Appl. No.: 17/254,731

(22) PCT Filed: May 20, 2019
(86) PCT No.: PCT/US19/33081

§ 371 Date: Dec. 21, 2020

Related U.S. Application Data
(60) Provisional application No. 62/688,445, filed on Jun. 22, 2018.

(51) Int. Cl. B60W 30/18; B60W 60/00; B60W 40/06; G06K 9/00

(52) U.S. Cl. CPC B60W 30/18163; B60W 60/0013; B60W 2552/53; G06K 9/00798; B60W 40/06

(57) ABSTRACT

A system and method to operate an autonomous vehicle on the road. The system and method may include determining a lane area on a road, calculating a first position within the lane area, determining a tolerance region within the lane area, calculating a deviation offset based on the tolerance region, calculating a second position based on the first position and the deviation offset, and causing to operate the autonomous vehicle to travel to the second position.

### REFERENCE TO RELATED APPLICATION

This application claims priority to U.S. Provisional Application 62/688,445 filed Jun. 22, 2018, the content of which is incorporated by reference in its entirety.

### TECHNICAL FIELD

The present disclosure relates to autonomous vehicles, and in particular, to a system and method to navigate autonomous vehicles along select tracks on the road.

### BACKGROUND

Autonomous vehicles (also known as self-driving vehicles) are automobiles that are capable of determining the environment surrounding the automobile and navigating, based on the determined environment, on the road with little or no human operator intervention. Autonomous vehicles may be equipped with multiple sensors to collect information about the environment. The sensors may include laser radar (lidar) sensors, video cameras, global positioning system (GPS) sensors, motion sensors (e.g., odometers) etc. A lidar sensor can determine the distances between the lidar sensor and objects within a certain range. A video camera may capture a sequence of time-coded images of the surrounding environment. The images may include information relating to objects (e.g., human objects, other vehicles, signages, and obstacles) on the road. The GPS sensor may identify the location of the vehicle. The motion sensor may determine the motion parameters (e.g., velocity, distance, etc.) of the vehicle. The vehicle may further include an onboard computing system that may include a processing device programmed to receive information from these sensors and, based on the received information, operate the vehicle with little or no human operator intervention.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates a vehicle system according to an implementation of the present disclosure.

FIG. 2 depicts a flow diagram of a method to calculate routes for autonomous vehicles according to an implementation of the present disclosure.

FIG. 3 illustrates an autonomous vehicle traveling in a lane according to an implementation of the present disclosure.

FIG. 4 illustrates functions capable of producing a longitudinal force according to an implementation of the present disclosure.

FIG. 5 depicts a flow diagram of a method to calculate routes for autonomous vehicles according to another implementation of the present disclosure.

FIG. 6 depicts a block diagram of a computer system operating in accordance with one or more aspects of the present disclosure.

### DETAILED DESCRIPTION

A vehicle traveling on the road can cause wear and tear on the surface of the road. These wear and tear may require expensive maintenance and repair of the road. When human operators drive vehicles on the road, many factors may influence the steering of the human operators. The variability of these factors among human operators may cause the vehicles to move on the road along a wide range of patterns and paths. The influencing factors may include human factors and environmental factors. The human factors may include the driving habits and risk tolerance of the human operators. For example, the behavior of human operators can be aggressive, normal, or conservative. The aggressive driver may make frequent lane changes; the normal driver may make lane changes at a lower rate than aggressive drivers; the conservative driver may avoid lane changes at any time. Further, some human operators may have higher risk tolerance, and may drive closer to the edges of the traveling lane. Other drivers may have lower risk tolerance and may drive in the center of the traveling lane. In this disclosure, a road may be composed of one or more lane areas (referred to as lanes) for vehicles travel thereon. Lanes may be separated by lane markers (e.g., dash/solid white lines). Thus, each lane may be bordered by two lane markers.

The environment factors may include other vehicles on the road (e.g., approaching and departing cars in neighbor lanes), the road conditions (e.g., straight lanes or curved lanes), and traffic conditions (e.g., driving on less congested highways or driving on the streets of a city). The human operators may react to these environment factors using their judgements under the influence of the human factors associated with each operator while driving on the road. Under the influence of these human and environmental factors, the vehicles driven by human operators tend to travel along less predictable tracks within a lane, where a track corresponds to the trace of the tires of the vehicle. Thus, the collection of human operated vehicles may cause more uniform and even wear and tear across the surface of the road.

In contrast, autonomous vehicles select the traveling tracks within a lane based on commands generated by a processing device. When each autonomous vehicle is operated under identical or similar instructions, the steering of autonomous vehicles lacks variability. The commands are generated based on information received from sensors (e.g., lidars, video cameras, GPS sensors, and motion sensors). The video cameras may capture images of the road including the lane markers of a lane in which the autonomous vehicle travels. The processing device may further execute an image analysis program (e.g., a deep learning neural network, reinforcement learning program, etc.) to detect the lane marker positions based on the images, and execute a drive decision program to determine the track for the vehicles to travel within the detected lane area bordered by the two lane markers. Autonomous vehicles are then operated to navigate within the lane. Without the influence of human factors discussed above, the drive decision program may plan the target position (a position to steer to) in the track within the lane based on the detected lane marker positions. For example, the drive decision program may command the autonomous vehicle to travel around the central line between the two parallel lane markers (e.g., two parallel white straight or curved lines). Another strategy is to travel in equal distances to other detected vehicles (e.g., detected front, rear, left, and right) within a certain range of the autonomous vehicle. When the majority of vehicles traveling on the road are autonomous vehicles employ similar or identical strategies to position the autonomous vehicles on tracks within lanes, the autonomous vehicles may travel along a substantially identical track in the lane. The autonomous vehicles that repeatedly travel along the same track within a lane can cause uneven wear and tear (e.g., tire tracks on an asphalt road) on the road that may shorten the service time of the road, require more frequent repairs, and increase road maintenance costs.

To overcome the above-identified and other deficiencies associated with autonomous vehicles, implementations of the present disclosure provide technical solutions that may cause the autonomous vehicles to travel along a wide range of variable tracks within a lane. In particular, implementations may determine a tolerance region between the two detected lane markers based on a calculated safety margin and a calculated passenger comfort margin. Further, implementation may incorporate random variations into the tracks of the autonomous vehicles, taking into consideration the limits of the determined tolerance region. Thus, the autonomous vehicles according to implementations of the present disclosure may travel along a variety of tracks uniformly distributed within the lane and cause substantially even wear and tear to the surface of the road and increase the service time of the road.

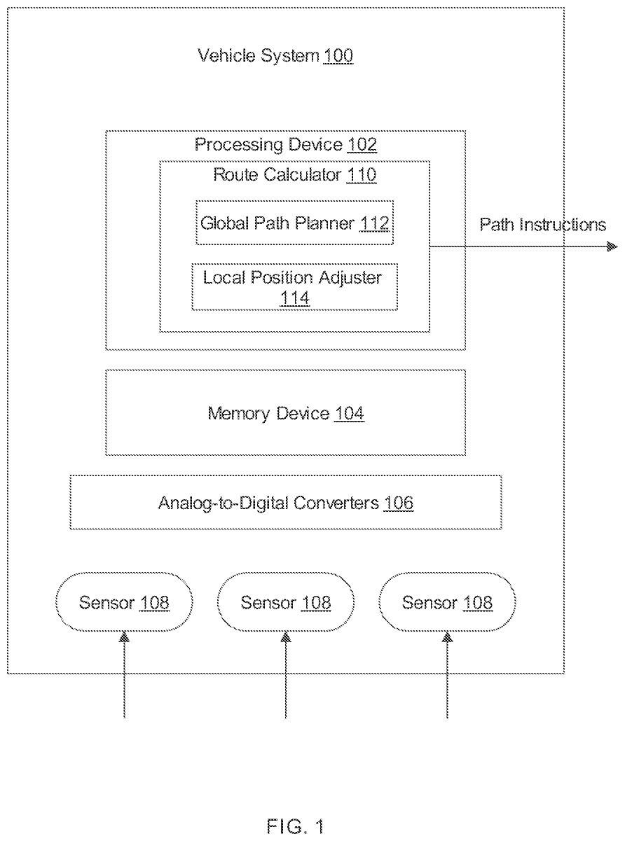

FIG. 1 illustrates a vehicle system 100 according to an implementation of the present disclosure. Vehicle system 100 can be a computing system onboard the autonomous vehicle to perform calculations associated with the driving of the autonomous vehicle. Referring to FIG. 1, vehicle system 100 may include a processing device 102, a memory device 104, analog to digital converters (ADCs) 106, and sensors 108. Processing device 102 can be a hardware processor such as, for example, a central processing unit (CPU), a graphic processing unit (GPU), or a general-purpose processing unit. Processing device 102 can be programmed to perform tasks relating to operating the autonomous vehicle.

Vehicle system 100 may further include a memory device 104 to store data and/or executable code that can be executed by processing device 102. Memory device 104 can be any suitable hardware storage such as, for example, random-access memory (RAM) device, hard disks, and/or cloud storage. In one implementation, vehicle system 100 may include sensors 108 for collecting information on the environment surrounding the autonomous vehicle. Sensors 108 may include hardware apparatus that may measure one or more environmental quantities and convert the environmental quantities into electrical signals. Sensors 108 may include, but not limited to, one or more of lidar sensors, one or more video cameras, one or more GPS sensors, and one or more motion sensors. The one or more lidar sensors may be situated towards the front, the rear, and/or the sides of the autonomous vehicle. Thus, the one or more lidar sensors can detect objects (e.g., other vehicles and pedestrians) in all directions with respect to the vehicle. Similarly, the one or more video cameras may be situated towards the front, the rear, and/or the sides of the autonomous vehicle. Thus, the one or more video cameras can also capture the images of objects in all directions with respect to the vehicle, including the lane markers on the road.

Sensors 108 may capture the information of the surrounding environment. The captured information may be measured in the form of electrical analog signals. Vehicle system 100 may further include one or more analog-to-digital converters (ADC) 106 to convert the analog signals received from sensors 106 into digital signals stored as data values in memory device 104. The data values can be the input to programs executed by processing device 102.

Processing device 102 may execute a route calculator 110 to generate operation instructions. The operation instructions may control the selection of the tracks within a lane in which the autonomous vehicle travels. In one implementation, route calculator 110 may include a global path planner 112 and a local position adjuster 114. Global path planner 112 may determine which roads to take to arrive at a destination using a road map based on preset rules. The preset rules can be any one of taking the route of the shortest time, taking the route of the shortest distance, or taking the route composed of the local roads. Global path planner 112 may employ a GPS sensor to determine the global position of the vehicle while it is traveling on the road. Further, global path planner 112 may be capable of dynamically changing the planned route based on the certain factors such as, for example, the traffic ahead and the weather.

Global path planner 112 can determine the route from a starting point to a destination point. The route may be formed by segments of roads that include one or more lanes separated by lane markers (e.g., dashed or solid while lines). Local position adjuster 114 may determine which lane to take when there is more than one lane to choose from and where to position the vehicle within the lane, where the positions in the lane form the track to travel. Alternatively, local position adjuster 114 may take into consideration both the lane and the positions within the lane to determine the vehicle track on the road.

In one implementation, local position adjuster 114 may calculate a first position for the autonomous vehicle based on a first set of rules. For example, the first position may be calculated to follow the center line between two parallel lane markers. Route calculator 110 may further calculate a tolerance region based on safety constraints and passenger comfort constraints. The tolerance region may include areas that contain permissible tracks under the safety constraint and passenger comfort constraints. Local position adjuster 114 may further calculate a second position by adding a deviation offset to the first position within boundaries of the tolerance region, where the offset may include random values or values calculated based on certain functions that simulate human operators. Local position adjuster 114 may issue instructions to navigate the autonomous vehicle along the second positions that are calculated in real time. As such, each autonomous vehicle may navigate along a respective independent and different track, and the collection of autonomous vehicles may travel at positions that are uniformly distributed within the lane on the road, thus reducing uneven wears and tears to the road surface and increasing the service time of the road.

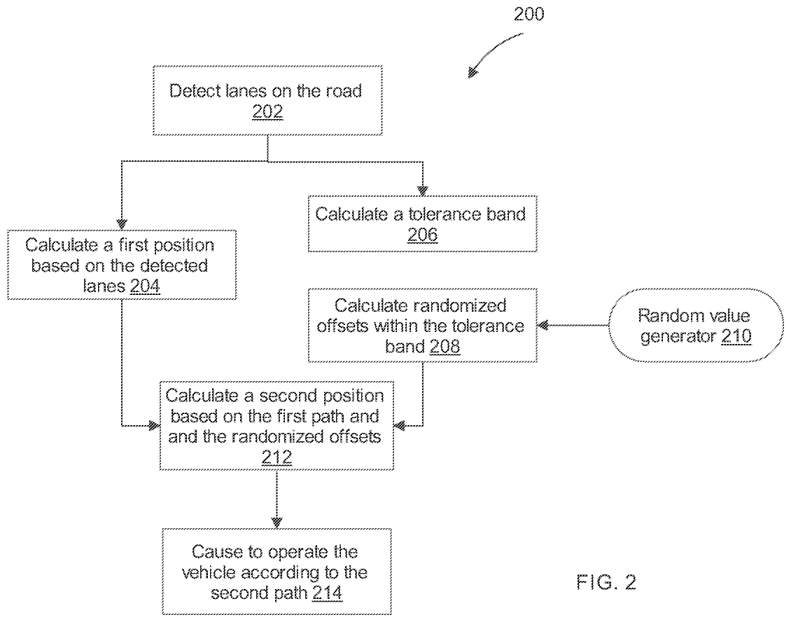

FIG. 2 depicts a flow diagram of a method 200 to calculate positions within a lane for autonomous vehicles according to an implementation of the present disclosure. Method 200 may be performed by processing devices that may comprise hardware (e.g., circuitry, dedicated logic), computer readable instructions (e.g., run on a general purpose computer system or a dedicated machine), or a combination of both. Method 200 and each of its individual functions, routines, subroutines, or operations may be performed by one or more processors of the processing device executing the method. In certain implementations, method 200 may be performed by a single processing thread. Alternatively, method 200 may be performed by two or more processing threads, each thread executing one or more individual functions, routines, subroutines, or operations of the method.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be needed to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media. In one implementation, method 200 may be performed by a processing device 102 executing route calculator 110 including local position adjuster 114 as shown in FIG. 1.

Referring to FIG. 2, at 202, the processing device may detect lane markers on the road based on data received from sensors 108 (e.g., video cameras). The two lane markers can be two parallel dashed or solid lines (either straight lines or curved lines, white or yellow). In some implementations, the lanes can be specified even without markers (e.g., invisible electronic lanes). In one exemplary implementation, sensors 108 may include one or more video cameras to record a sequence of time-coded image frames. The image frames may include images of the road including the lane markers. Each image frame may include a grey level or color image having a pre-determined resolutions (e.g., 512×1024 pixels). Processing device 102 may execute an image analysis program to analyze the images and detect the positions of the lane markers with respect to a reference point on the autonomous vehicle. The lane markers can be two parallel lines (or dashed lines) separated by a lane area (referred to as the lane). Each lane marker may have a certain width (e.g., eight inches), and the distance between the inner edges of the two lane markers represents the width of the lane. The lane width may be in a range of three to eight yards depending on where the lanes are located.

At 204, based on the detected lane markers, the processing device may further calculate the width of the lane and determine the position of a center line within the lane. The center line of the lane is the trace of the halfway mark positions between the two inner edges of the two lane markers. The processing device may decide a first position based on the center line of the lane. For example, the first position of the autonomous vehicle is commonly specified along the center line. Namely, the processing device commonly operates the autonomous vehicle to travel within the lane in such a manner that the longitudinal axis of the autonomous vehicle moves substantially along the center line of the lane. Even taking into consideration of the variety of vehicle widths on the road, the tires of the autonomous vehicles may cause two parallel tire tracks in the lane if every autonomous vehicles on the road use the same first track.

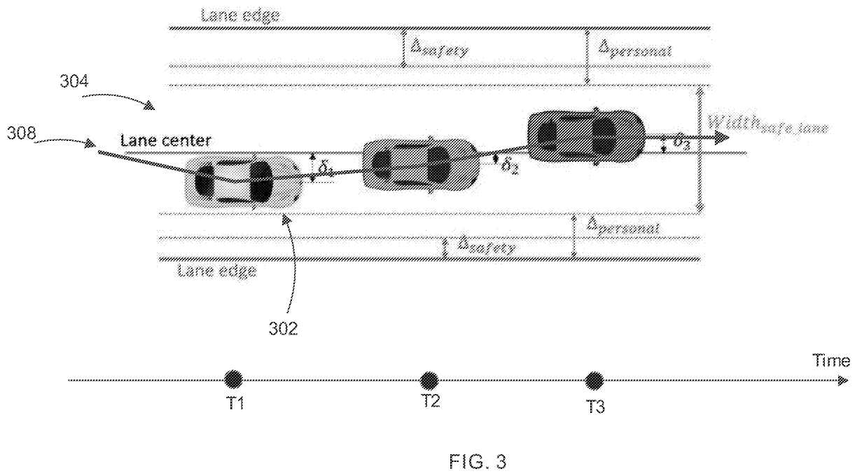

Implementations of the present disclosure may add variations to the first position determined at 204 within safety constraints and passenger comfort constraints. At 206, processing device may determine a tolerance region within the lane area, where the tolerance region is an area within the lane area that, when the vehicle travels in the area, the vehicle meets the safety constraints and/or the passenger comfort constraints. The safety constraints may specify margins to the edge of the lane marker based on a set of safety rules. Processing device may determine that it is unsafe to violate the specified margins based on the safety rules. The safety rules may include the minimum separation between vehicles in two adjacent lanes and a minimum distance to the inner edges of the lane marker. FIG. 3 illustrates an autonomous vehicle 302 traveling in a lane according to an implementation of the present disclosure. As shown in FIG. 3, along the inner edges of lane markers, processing device may identify a safety margin Δ_{safety} (shown as the width_{safe_lane}) along each edge of the lane, where the region within the width_{safe_lane} represents the tolerance region. The autonomous vehicle cannot violate the safety margins because the violation is deemed as unsafe operation. Further, the processing device may also consider passenger's comfort and calculate a passenger comfort margin Δₚₑᵣₛₒₙₐₗ along each side of the lane. The passenger's comfort factors may include avoiding a wide swing between the inner edges of the two lane markers because the wide swings may cause motion sickness on passengers of the autonomous vehicle, and reducing the unease of the passengers when vehicles in two adjacent lanes are too close. As shown in FIG. 3, the passenger comfort margin may be wider than the safety margin. In another implementation, the passenger comfort margin may be narrower than the safety margin. Processing device may calculate a tolerance region within the lane by taking into consideration of the safety margin and the passenger comfort margin. For example, the tolerance region may be a combined area excluding the safety margin and the personal comfort margin. When the autonomous vehicle travels within the tolerance region, the autonomous vehicle does not violate either the safety margin or the passenger comfort margin.

At 208, the processing device may calculate deviation offsets with respect to the calculated first position (e.g., the center line between two corresponding lane markers). The offsets are perpendicular deviations from the first position with respect to the lane markers. As shown in FIG. 3, the longitudinal axis of the autonomous vehicle may deviate from the center line by offsets (δ₁, δ₂, δ₃) which measure the perpendicular distances between the center line of the lane and the longitudinal axis of the autonomous vehicle. The processing device may add random variations into the values of the offsets along the center line, thus operating the autonomous vehicle along a variety of tracks. In one implementation, at 210, the processing device may generate random values within a range as the offsets. For example, the processing device may execute a random value generator to generate random values as the offsets. To ensure that the generated offsets will not cause violations of the safety margin and the passenger comfort margin, the random value generator may generate the random values modulated by the half width of the tolerance region. Thus, the generated random values are no more than the half width of the lane width.

At 212, the processing device may calculate a second position for the autonomous vehicle based on the first position and the calculated offsets with respect to the first position. In one implementation, the processing device may directly deviate the first position by the amount of the calculated offsets. In another implementation, the processing device may deviate the first position through a function that simulate human driving patterns.

At 214, the processing device may issue commands to operate the autonomous vehicle to navigate to a second position that factors in both the first position and the offset. The autonomous vehicles navigated to the second position may, as a whole, travel in tracks distributed uniformly the area between two lane markers on the road surface. The collection of autonomous vehicles on the road may cause less road wear and tear and increase the service time of the road.

FIG. 3 illustrates a lane in which the autonomous vehicle 302 travels along a track including random offsets from the center line of the lane according to an implementation of the present disclosure. As shown in FIG. 3, there are safety margins Δ_{safety} and passenger comfort margins Δₚₑᵣₛₒₙₐₗ along the edges of lane markers. The two margins may overlap. The tolerance region 304 is the narrowest region between the safety margins and the passenger comfort margins. The tolerance region 304 may include the lane center (which includes the first positions). Processing device 102 may calculate offsets between the vehicle longitudinal axis and the lane center line at different time instances (e.g., T1, T2, T3), where the offsets may include a deviation value bounded by the tolerance region. As shown in FIG. 3, at T1, T2, T3, the offset can be δ₁, δ₂, δ₃ respectively. Thus, autonomous vehicle 302 may travel to a second position 308 that includes deviations from the lane center line. Although FIG. 3 illustrates a straight lane, implementations of the disclosure may be similarly applied to non-straight lanes such as, for example curved lanes.

FIG. 3 illustrates an implementation in which random value offsets are directly added to the first positions (e.g., along the center line) to produce a second position for the autonomous vehicle. In other implementations, the offsets may be added to the first positions through functions that simulate the driving patterns of human operators. For example, human operators may apply both lateral and longitudinal forces to the road. To simulate the human operators' driving patterns, implementations of the disclosure may use a function of time to represent the offsets, where the function may provide both lateral and longitudinal forces to the road surface, thereby both replicating human driving patterns and providing more even wear and tear to the road surface. The simulation of a human operators' driving patterns may provide a familiar comfort to the passengers who are accustomed to human driving patterns.

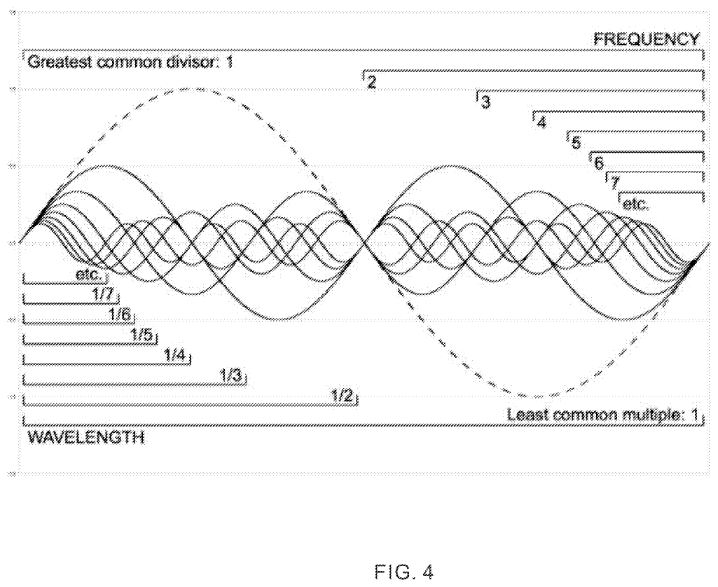

FIG. 4 illustrates a such function capable of producing both a lateral and longitudinal force when the function is used to calculate offsets according to an implementation of the present disclosure. As shown in FIG. 4, a sine function can be used to calculate the offsets to the lane center line. The sine function is specified by its amplitude, frequency, and phase. The amplitude can be modulated by the width of the tolerance region; the phase is determined by the starting position of the sine function; the frequency can be determined by the generated random value. As shown in FIG. 4, the different frequency values (or alternatively, the wavelength values) may produce different sine waves which may affect the offsets from the lane center line. In one implementation, the processing device of the vehicle system may generate a random value which may be mapped to a unique frequency value for the sine function associated with the vehicle. Thus, the track of each autonomous vehicle may be selected based on a unique frequency for a sine function. In another implementation, the processing device may periodically generate a random value. Thus, different portions of the track of an autonomous vehicle may be associated with different frequency values.

In one implementation, the safety constraints and passenger comfort constraints may also limit the range of frequency values. High frequencies may cause the autonomous vehicle to rapidly change positions, causing at least passenger discomfort or vehicle un-stability. Thus, the frequency value of the sine function may be confined by an upper limit value. While the example implementation of FIG. 4 is discussed in terms of sine functions, other types of functions may also be used to calculate the offsets. For example, the function can be other trigonometric functions, splines, piece-wise continuous functions, a function approximated by a neural network, etc.

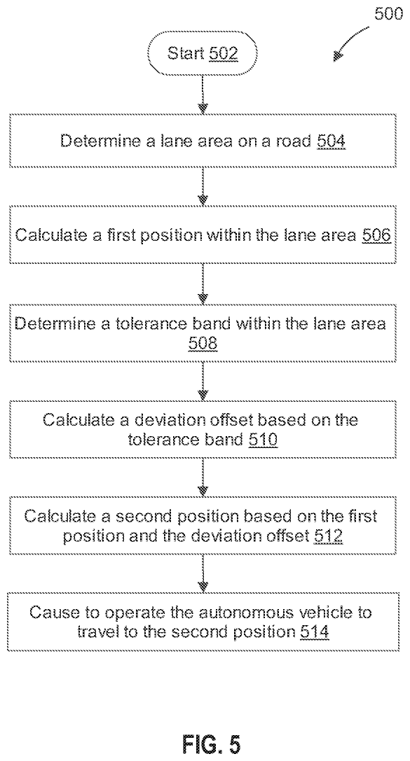

FIG. 5 depicts a flow diagram of a method 500 to calculate routes for autonomous vehicles according to another implementation of the present disclosure. As shown in FIG. 5, at 502, a processing device may start performing method 500 for operating an autonomous vehicle.

At 504, the processing device may determine a lane area on a road.

At 506, the processing device may calculate a position within the lane area.

At 508, the processing device may determine a tolerance region within the lane area.

At 510, the processing device may calculate a deviation offset based on the tolerance region.

At 512, the processing device may calculate a second position based on the first position and the deviation offset.

At 514, the processing device may cause to operate the autonomous vehicle to travel to the second position.

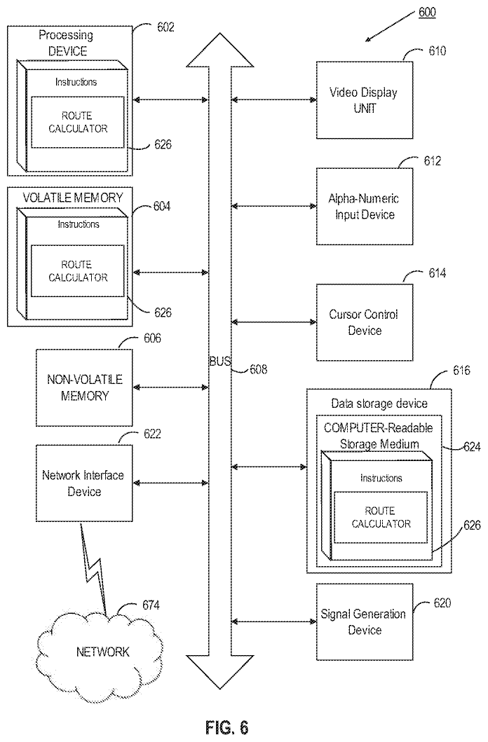

FIG. 6 depicts a block diagram of a computer system operating in accordance with one or more aspects of the present disclosure. In various illustrative examples, computer system 600 may be a system onboard vehicle system 100 of FIG. 1.

In certain implementations, computer system 600 may be connected (e.g., via a network, such as a Local Area Network (LAN), an intranet, an extranet, or the Internet) to other computer systems. Computer system 600 may operate in the capacity of a server or a client computer in a client-server environment, or as a peer computer in a peer-to-peer or distributed network environment. Computer system 600 may be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 600 may include a processing device 602, a volatile memory 604 (e.g., random access memory (RAM)), a non-volatile memory 606 (e.g., read-only memory (ROM) or electrically-erasable programmable ROM (EEPROM)), and a data storage device 616, which may communicate with each other via a bus 608.

Processing device 602 may be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 600 may further include a network interface device 622. Computer system 600 also may include a video display unit 610 (e.g., an LCD), an alphanumeric input device 612 (e.g., a keyboard), a cursor control device 614 (e.g., a mouse), and a signal generation device 620.

Data storage device 616 may include a non-transitory computer-readable storage medium 624 on which may store instructions 626 encoding any one or more of the methods or functions described herein, including instructions of the route calculator 110 of FIG. 1 for implementing method 200 as shown in FIG. 2 or method 500 as shown in FIG. 5.

Instructions 626 may also reside, completely or partially, within volatile memory 604 and/or within processing device 602 during execution thereof by computer system 600, hence, volatile memory 604 and processing device 602 may also constitute machine-readable storage media.

While computer-readable storage medium 624 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

Unless specifically stated otherwise, terms such as “receiving,” “associating,” “determining,” “updating” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may comprise a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform method 300 and/or each of its individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

1. A method for operating an autonomous vehicle, comprising:
determining, by a processing device, a lane area on a road;
calculating, by the processing device, a first position within the lane area;
determining, by the processing device, a tolerance region within the lane area;
calculating, by the processing device, a deviation offset based on the tolerance region;
calculating, by the processing device, a second position based on the first position and the deviation offset; and
causing, by the processing device, to operate the autonomous vehicle to travel to the second position.

2. The method of claim 1, wherein determining the lane area on the road further comprises:
receiving images of the road, the images comprising at least one lane marker that borders the lane area;
analyzing the images to determine the at least one lane marker in the images; and
determining the lane area based on the determined at least one lane marker.

3. The method of any of claim 1 or 2, wherein calculating the first position within the lane area further comprises calculating the first position based on the at least one lane marker.

4. The method of claim 3, wherein the at least one lane marker comprises two lane markers that borders the lane area on opposite sides, and wherein the calculated first position is a center point between the two lane markers.

5. The method of claim 3, wherein determining the tolerance region within the lane area comprises determining the tolerance region based on at least one of a safety rule or a passenger comfort rule, and wherein the tolerance region comprises the first position and is defined between the two lane markers.

6. The method of claim 5, wherein the safety rule comprises a first minimum distance between a first vehicle in a first lane area and a second vehicle in a second lane area adjacent to the first lane area, and wherein the passenger comfort rule comprises a second minimum distance from the vehicle to each one of the two lane markers.

7. The method of claim 5, wherein calculating the deviation offset based on the tolerance region comprises:
generating a random value; and
calculating the deviation offset as a function of the random value.

8. The method of claim 5, wherein calculating the second position comprises adding the deviation offset to the first position.

9. The method of claim 1, further comprising:
calculating the first position with respect to a reference point of the autonomous vehicle; and
calculating the second position based on the first position and the deviation offset with respect to the reference point.

10. An autonomous vehicle system, comprising:
a sensor device for capturing images of a road;
a storage device for storing instructions;
a processing device, communicatively coupled to the sensor device and the storage device, for executing the instructions to:
determine a lane area on a road;
calculate a first position within the lane area;
determine a tolerance region within the lane area;
calculate a deviation offset based on the tolerance region;
calculate a second position based on the first position and the deviation offset; and
cause to operate the autonomous vehicle to travel to the second position.

11. The autonomous vehicle of claim 10, wherein to determine the lane area, the processing device is further to:
receive the images of the road from the sensor device, the images comprising at least one lane marker that borders the lane area;
analyze the images to determine the at least one lane marker in the images; and
determine the lane area based on the determined at least one lane marker.

12. The autonomous vehicle of any of claim 10 or 11, wherein to calculate the first position within the lane area, the processing device is to calculate the first position based on the at least one lane marker.

13. The autonomous vehicle of claim 12, wherein the at least one lane marker comprises two lane markers that borders the lane area on opposite sides, and wherein the calculated first position is a center point between the two lane markers.

14. The autonomous vehicle of claim 12, wherein to determine the tolerance region within the lane area, the processing device is to determine the tolerance region based on at least one of a safety rule or a passenger comfort rule, and wherein the tolerance region comprises the first position and is defined between the two lane markers.

15. The autonomous vehicle of claim 14, wherein the safety rule comprises a first minimum distance between a first vehicle in a first lane area and a second vehicle in a second lane area adjacent to the first lane area, and wherein the passenger comfort rule comprises a second minimum distance from the vehicle to each one of the two lane markers.

16. The autonomous vehicle of claim 14, wherein to calculate the deviation offset based on the tolerance region, the processing device is to:
generate a random value; and
calculate the deviation offset as a function of the random value.

17. The autonomous vehicle of claim 14, wherein to calculate the second position, the processing device is to add the deviation offset to the first position.

18. A non-transitory machine-readable storage medium storing instructions which, when executed, cause a processing device to perform operations comprising:
determining, by the processing device, a lane area on a road;
calculating, by the processing device, a first position within the lane area;
determining, by the processing device, a tolerance region within the lane area;
calculating, by the processing device, a deviation offset based on the tolerance region;
calculating, by the processing device, a second position based on the first position and the deviation offset; and
causing, by the processing device, to operate the autonomous vehicle to travel to the second position.

19. The non-transitory machine-readable storage medium of claim 18, wherein determining the lane area on the road further comprises:
receiving images of the road, the images comprising at least one lane marker that borders the lane area;
analyzing the images to determine the at least one lane marker in the images; and
determining the lane area based on the determined at least one lane marker.

20. The non-transitory machine-readable storage medium of any of claim 18 or 19, wherein calculating the first position within the lane area further comprises calculating the first position based on the at least one lane marker.
